(19) United States
(12) Patent Application Publication
(10) Pub. No.: US 2008/0040942 A1
(43) Pub. Date: Feb. 21, 2008

(54) Position Measurement

(75) Inventors: Marcus James Eales, Stroud (GB); Alan James Holloway, Wotton-under-Edge (GB)

Correspondence Address: OLIFF & BERRIDGE, PLC, P.O. BOX 320850, ALEXANDRIA, VA, 22320-4850, US

(73) Assignee: RENISHAW PLC, Wotton-Under-Edge (GB)

(21) Appl. No.: 11/791,263

(22) PCT Filed: Dec. 22, 2005
(86) PCT No.: PCT/GB05/05028

§ 371 Date: May 22, 2007

(30) Foreign Application Priority Data
Dec. 23, 2004 (GB) 0428165.5

(51) Int. Cl. G01D 5/34

(52) U.S. Cl. 33/707

(57) ABSTRACT

A measurement system has a measurement scale pattern (10) and sensor (12) moveable relative to one another. The measurement scale pattern has a pattern of features (14) arranged into groups, each group having a known absolute position. The sensor (12) has a field of view sufficient to detect one or more features simultaneously. Relative movement between the sensor (12) and measurement scale pattern (10) is constrained in two or more degrees of freedom. A processor determines the position of the sensor or an object connected to the sensor relative to the measurement scale pattern in at least one linear and one rotational degree of freedom.

The present invention relates to the measurement of the position of an object in two dimensions.

A single-axis position encoder is a device for measuring the relative position of two objects along one axis. Typically, a scale is attached to one of the objects and a read head to the other. The read head contains a light source which illuminates the scale and a sensor or sensors for detecting the scale markings. In an incremental measurement system, the scale markings form a periodic pattern and the read head provides outputs which allow the markings to be counted to keep track of position. In an absolute measurement system, the scale markings may form code words and the readhead decodes the code words to determine the absolute position.

Dual-axis incremental position encoders also exist. In the simplest case, these include two read heads mounted together at right angles to each other, and a scale with periodicity in two usually orthogonal directions, each read head measuring incremental movement in a respective one of the two directions. Such a dual axis incremental encoder is disclosed in European patent application EP 1106972.

European patent application EP 1099936 describes a two-dimensional absolute measurement scale which has a surface divided into a matrix of cells, each cell containing one bit of information. The values of the bits on the scale are arranged to form code words such that by reading some sub-set of all the bits on the scale, the absolute position of the electronic reading apparatus can be determined in two directions.

The present invention provides a measurement system having a measurement scale pattern and sensor moveable relative to one another, the measurement system comprising:
a measurement scale pattern having a pattern of features arranged into groups, each group having a known absolute position;
at least one sensor, said at least one sensor having a field of view sufficient to detect one or more features simultaneously, wherein relative movement between the said at least one sensor and measurement scale pattern is constrained in two or more degrees of freedom;
a processor to determine the position of the sensor or an object connected to the at least one sensor relative to the measurement scale pattern in at least one linear and one rotational degree of freedom.

Preferably the relative movement between the at least one sensor and the measurement scale pattern is constrained from rotation about axes parallel to the plane of the measurement scale pattern. Relative movement between the at least one sensor and the measurement scale pattern may also be constrained from linear movement in a direction perpendicular from the plane of the measurement scale pattern.

Preferably the processor used the detected position of the one or more feature to determine the position of the at least one sensor relative to the measurement scale pattern.

This system thus enables relative translational movement of the at least one sensor parallel to the plane of the measurement scale pattern and relative rotational movement of the at least one sensor about an axis perpendicular to the plane of the measurement scale pattern to be determined. In addition, relative translational movement of the at least one sensor in a direction perpendicular to the measurement scale pattern may also be determined.

The measurement scale pattern may comprise a two-dimensional or one dimension scale pattern.

The at least one sensor preferably comprises a two dimension sensor, such as a camera.

The relative position of the measurement scale pattern and at least one sensor may be determined from a single feature (i.e. an elongate feature) or from two or more separate features.

Each group of features may include a marker feature having a quality which is the same in each group.

The marker feature may have a quality which is different from all the other features in each group. Thus the marker feature may be differentiated from the other features. The marker feature may have a different colour from all the other features in each unit.

Preferably two or more marker features are detected by the at least one sensor and used to determine the relative orientation of the at least one sensor and measurement scale pattern.

The position of the features in each group may be identical, with only the quality of the features changing between each group.

The features may have a multilevel coding. The features may be chosen from a variety of colours.

The advantage of each of the features having a multilevel coding means that fewer features can be used to code the positional information than, for example, a binary code. Thus this invention allows absolute position information to be determined to a higher resolution than with a binary code.

The unit may have one or more features which identify the X position and one or more features which identify the Y position.

The at least one sensor may comprise two sensors in a fixed relationship with one another.

The displacement of the image of a feature from its expected position may be used to determine the relative velocity between the measurement scale pattern and the at least one sensor.

A second aspect of the present invention provides a method of measuring the relative position of a measurement scale pattern and at least one sensor which are moveable relative to one another, the measurement scale pattern being provided with a pattern of features arranged into groups, each group having a known absolute position, and the at least one sensor being constrained in two or more degrees of freedom, the method comprising the steps of:
detecting one or more features of the measurement scale pattern at the at least one sensor;
determining the position of said one or more scale features on the at least one sensor;
and thereby determining the position of the at least one sensor or an object connected to the at least one sensor relative to the measurement scale pattern in at least one linear and one rotational degree of freedom.

Two or more features may be detected by the at least one sensor, and the method further comprising the following steps: determining the position of the images of the two or more features, whose absolute positions are known; determining the ratio of the distances between the two or more features and a datum position on the at least one sensor; and using the ratio of the distances between the two or more features and a datum position to determine the actual distance of the images of the two or more features to the datum position.

A third aspect of the present invention provides a measurement scale comprising:
a pattern of features arranged into groups;
wherein each group has a feature, the position of which is known with respect to the group; and
each group has one or more subsidiary feature which defines the position of the group, the subsidiary features being provided with multi-level coding.

In addition, each group may have a feature, the position of which is known with respect to similar features in other groups. The feature whose position is known with respect to the group and the feature whose position is known with respect to similar features in other groups may be the same feature.

The multi-level coding may comprise the use of different colours.

A fourth aspect of the present invention provides a measurement scale comprising:
a pattern of features arranged into groups;
wherein each group has a feature, the position of which is known with respect to similar features in other groups; and
each group has one or more subsidiary feature which defines the position of the group, the subsidiary features being provided with multi-level coding.

A fifth aspect of the present invention provides a measurement system comprising a measurement scale and at least one sensor, the measurement scale and sensor being moveable relative to one another, having the measurement scale pattern above.

A sixth aspect of the present invention provides a method for measuring the relative position of a measurement scale pattern and at least one sensor which are moveable relative to one another, the measurement scale pattern being provided with a pattern of features, the method comprising the steps of:
detecting two or more features on the scale;
determining the position of the images of the two or more features, whose absolute positions are known;
determining the ratio of the distances between the two or more features and a datum position on the sensor; and
using the ratio of the distances between the two or more features and a datum position to determine the actual distance of the images of the two or more features to the datum position.

A seventh aspect of the present invention provides a method for measuring the relative position of a measurement scale pattern and at least one sensor which are moveable relative to one another, the measurement scale pattern being provided with a pattern of features, the method comprising the steps of:
detecting one or more features of the measurement scale pattern at the at least one sensor;
determining the position of said one or more scale features on the at least one sensor;
wherein the displacement of the image of a feature from its expected position is used to determine the relative velocity between the measurement scale pattern and the at least one sensor.

The present invention will now be described by way of example with reference to the accompanying drawings, in which:

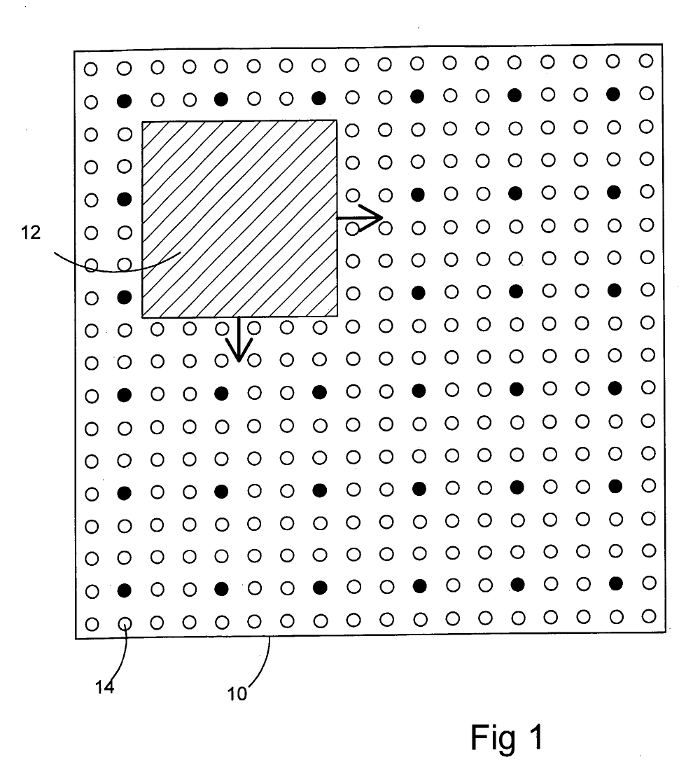

FIG. 1 illustrates a plan view of the 2D grid and readhead;

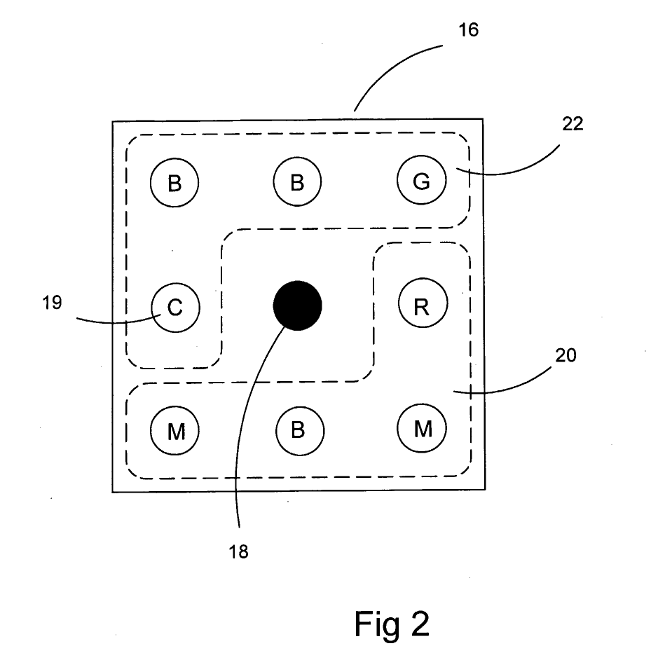

FIG. 2 is a plan view of a basic unit of the 2D grid of FIG. 1;

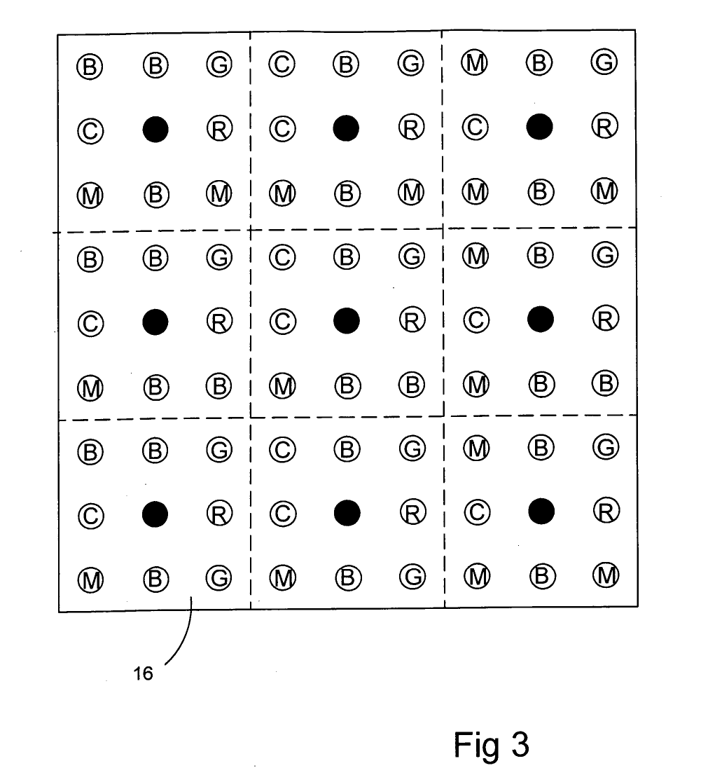

FIG. 3 is a section of the grid of FIG. 1;

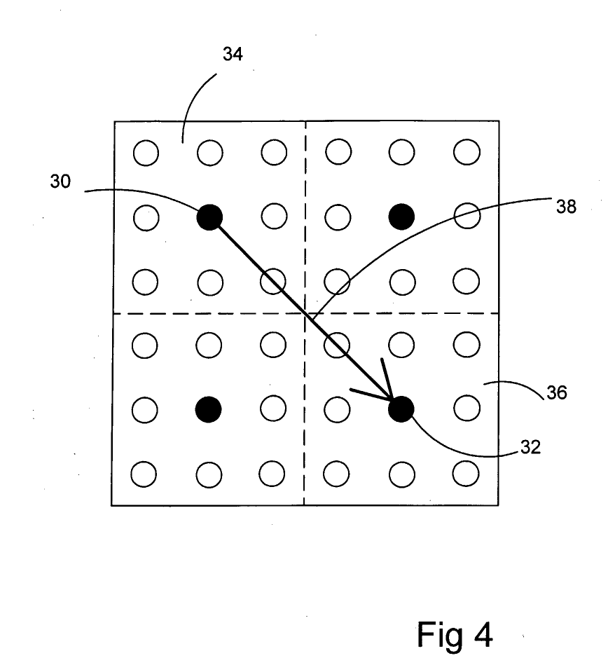

FIG. 4 is a section of the grid of FIG. 1, illustrating the direction vector between adjacent central dots;

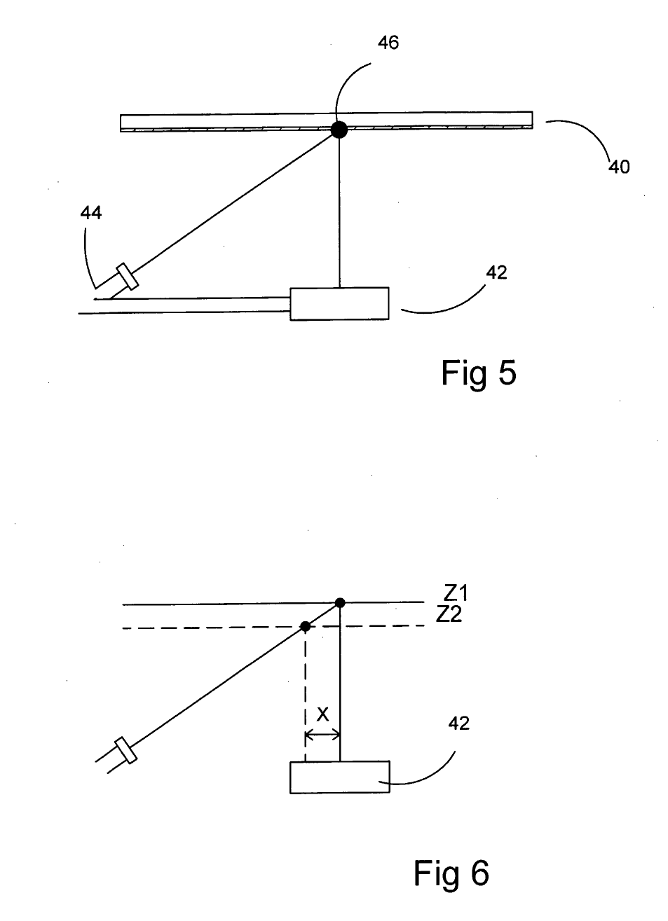

FIG. 5 is a side view of a second embodiment, showing the grid, camera and additional light source;

FIG. 6 a schematic illustration of the embodiment of FIG. 5, showing the grid at different heights;

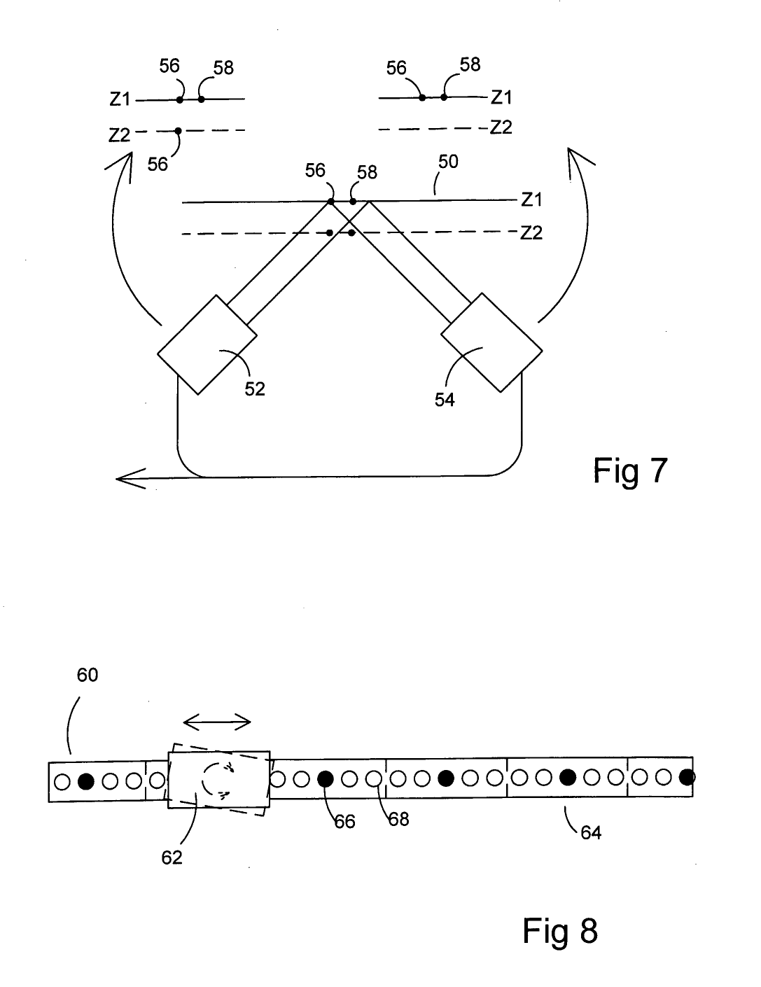

FIG. 7 is a side view of a third embodiment, showing the grid an two cameras;

FIG. 8 is a plan view of a linear scale and readhead;

FIG. 9 is a schematic illustration of a an alternative embodiment of the system which enables Z translation to be measured;

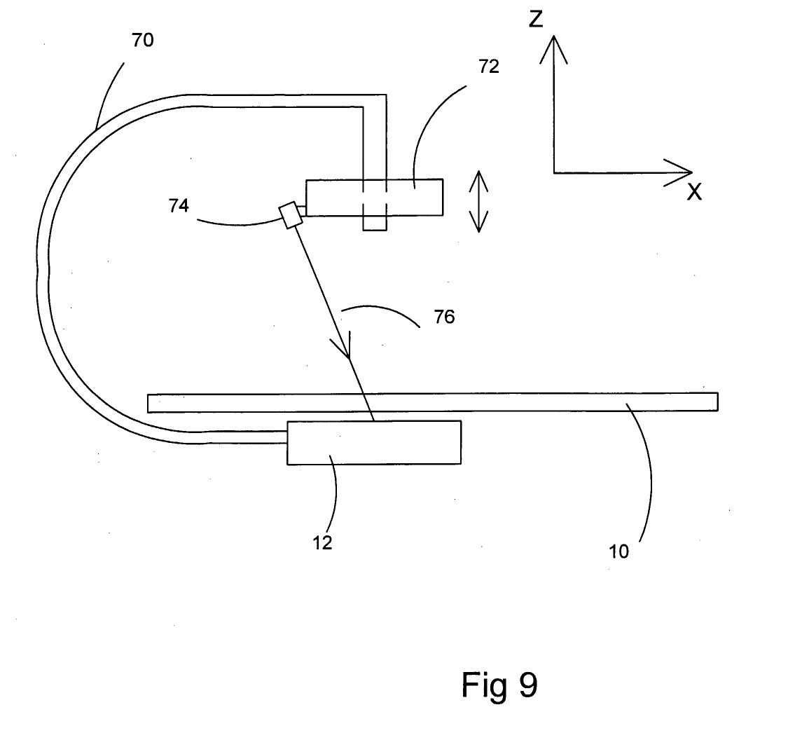

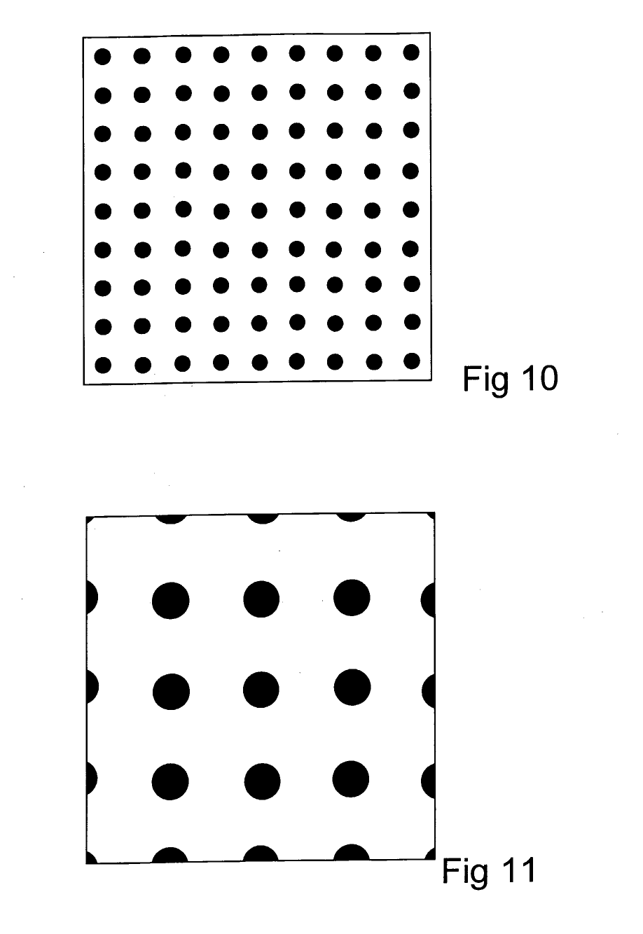

FIG. 10 is an illustration of the image detected by the camera at a first height above the grid;

FIG. 11 is an illustration of the image detected by the camera at a second height above the grid;

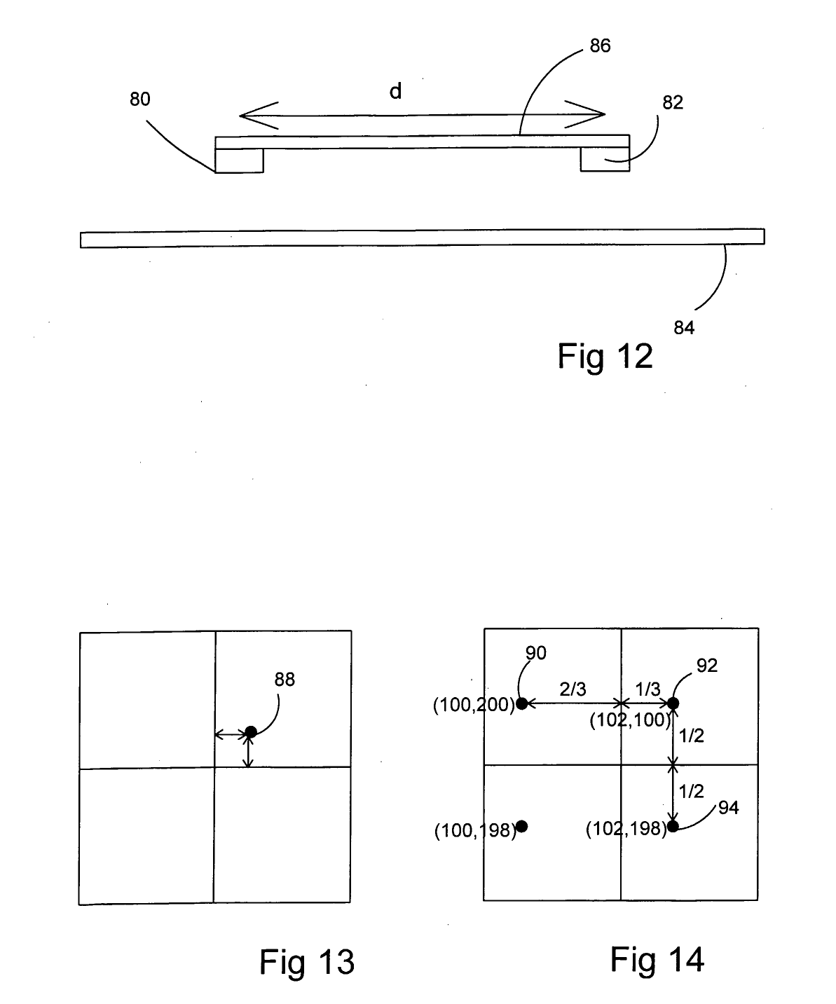

FIG. 12 illustrates an embodiment of the invention using two sensors;

FIG. 13 illustrates the detected image of a dot on the measurement grid using a single sensor;

FIG. 14 illustrates the detected image of two dots on the measurement grid using the sensor arrangement of FIG. 12;

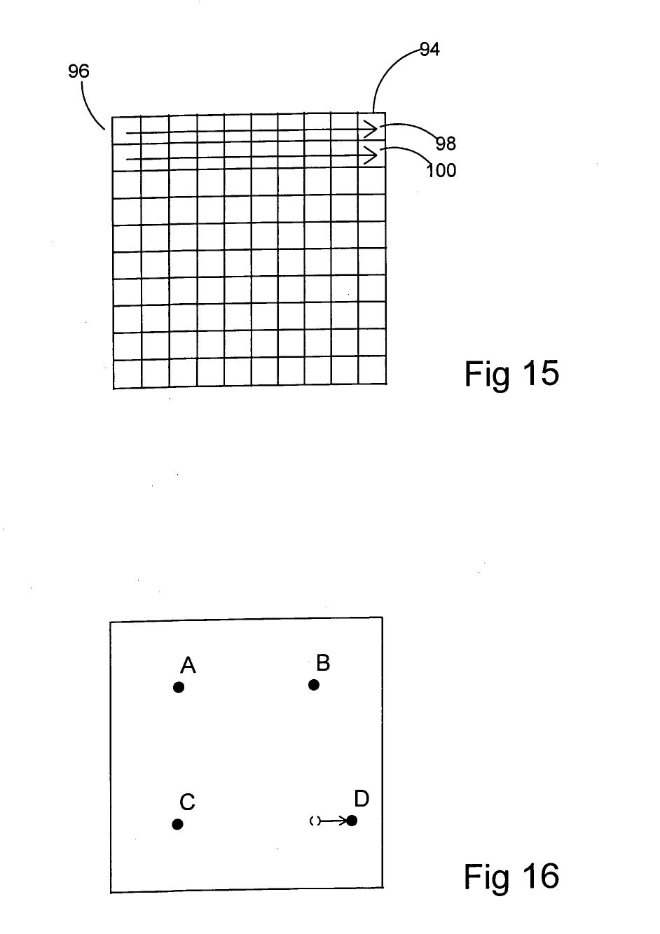

FIG. 15 illustrates a raster scan of the pixels of the sensor; and

FIG. 16 illustrates images of dots on the sensor.

FIG. 1 illustrates a plan view of a 2D scale and readhead of the invention. The scale 10 and readhead 12 may be mounted on members (not shown) which are moveable with respect to one another in a plane parallel to the plane of the scale.

The grid comprises a matrix of dots 14. The matrix is made from a series of basic units, each comprising nine dots. FIG. 2 illustrates a plan view of a basic unit 16 of the matrix. This comprises a marker feature comprising a central dark dot 18 surrounded by eight coloured dots 19. The basic units differ from one another by changing the colour of the coloured dots 19. The matrix is built up from these basic units, each basic unit having a different arrangement of the colours of the coloured dots.

The position of each black dot is known relative to the coloured features of the group. The position of each black dot is also known relative to the black dots in other group. The position of the black dots in different groups may be determined by mapping the grid, for example.

In each basic unit, four of the coloured dots 20 are used to code the position along the X axis and four of the coloured dots 22 are used to code the position along the Y axis.

FIG. 3 illustrates basic units making up a portion of the grid. All the basic units with the same X position have the same pattern of coloured dots for the four dots denoting the X position. Likewise, all the basic units with the same Y position have the same pattern of coloured dots for the four dots denoting the Y position. However, basic units with different X positions will have different patterns of coloured dots for the four dots denoting the X positions.

Using four dots for each of the X and Y positions enables a large amount of positions to be encoded. For example, if six colours are used for the four dots (e.g. green, red, blue, cyan, magenta+yellow), then 6⁴ combinations are possible, i.e. 1294 combinations.

The readhead comprises a sensor, such as a camera or other 2D optical detector, such as a charge coupled detector (CCD). A light source may also be provided to illuminate the grid. The camera detects the dots and enables the position of each dot to be determined.

A lens may be provided to focus the image of the dots onto the sensor in known manner.

In the present embodiment, the relationship between feature size on the grid and image size on the sensor is 1:1. This has the advantage that image distortions at the sensor are theoretically eliminated. However they could alternatively be error mapped.

If the sensor is constrained to move in the XY plane, the sensor can have fixed focus. Likewise, the light source used to illuminate the grid can be fixed, producing a flat illumination.

When a basic unit is imaged with the camera, the position of the readhead relative to the scale may be determined. By detecting the pattern of coloured dots around the central black dot, the basic unit with that pattern of coloured dots is recognised. A controller may compare the detected pattern of the basic unit with known patterns from a look up table. By determining the location of the image of the central black dot of the basic unit on the camera, the exact position of the camera relative to the grid can be determined

The position of the image of the black dot on the camera is found by determining its centre. This may simply be done for example by detecting the circumference of the dot and deducing the centre from it. Using the centres of the dots to locate the position of the dots reduces the image processing required by the sensor and enables a low resolution sensor to be used.

It is not necessary to find the centres of the coloured dots, as only their colour and approximate positions are required in order to identify which unit a black dot belongs to. Thus the invention has the advantage of simple image processing. In addition the invention has the advantage that the grid is easy to produce as only the black dots need to be positioned accurately. Errors in the positions of the coloured dots do not effect the position readings.

This invention has the advantage that not only can translational movement of the camera relative to the grid be determined, but rotational movement of the camera in the XY plane can also be determined as described below.

The viewing window of the camera is large enough that two basic units can be seen at any one time. FIG. 4 illustrates the grid as imaged onto the camera. By determining the XY position of two black dots 30,32 in two basic units 34,36, the vector 38 from one black dot 30 to the other 32 can be determined. By determining the directional relationship between two black dots, the orientation of the camera relative to the grid in the XY plane can be determined. This calculation may be carried out in a processor associated with the sensor.

In the embodiments illustrated in FIGS. 1-4, the basic units are square and thus enable the orientation of the sensor relative to the measuring scale to be determined for relatively small angles. However a rotation of 90° cannot be differentiated from a different basic unit. Use of a different shape of basic unit, for example a rectangular shape made up of a 4×2 pattern of dots, would enable 90° orientations to be determined but the same problem would be encountered for 180° orientations. A non symmetric marking may be included in the basic unit so that the absolute position of the basic unit can be determined throughout 360°.

The black dots could be replaced by features of another shape, for example a hyphen shape. In this case, only one hyphen would need to be detected to determine the orientation of the camera relative to the grid.

The relative orientation may be determined using several sets of black dots (or other features) and the results averaged to gain a more accurate result.

The pattern of coloured dots could be replaced with a pattern of different shapes or a pattern or dots with different spacings. Alternatively, dots of different reflectivity could be used.

The camera is preferably constrained to move only in the plane of the scale (i.e. in the XY plane and to rotate about Z). By so constraining the camera, the position of the part of interest can be deduced to a greater accuracy than would be possible if movement was allowed in all 6 degrees of freedom. This is because, although rotation about X or Y and movement in the Z direction can be deduced by looking at the scale, these terms cannot typically be determined to the same accuracy as movement in the X or Y direction or rotation about the Z axis. Any error in calculating rotation about the X or Y axis will be multiplied by the distance between the scale plane and the point of interest. Rotation about X and Y will also effect the accuracy of the position reading in the XY plane and about Z. Thus by constraining the relative movement of the scale and camera, the system is able to detect position to a high accuracy, e.g. sub-micron level.

This system can also be used to determine relative displacement between the grid and the camera in Z. FIG. 5 shows a system in which the camera 42 is moveable relative to the grid 40 in X,Y and Z. A light source 44, for example a laser, which is located in a fixed position relative to the camera 42, is used to project a light spot 46 onto the grid 40. The light source 44 is set at an angle, e.g. 45°, to the camera 42. As the camera 42 moves in Z relative to the grid 40, the position of the light spot 46 as detected by the camera 42 will move in X. Thus by measuring the position of the light spot 46 on the camera 42, the relative displacement of the grid 40 and camera 42 can be determined.

FIG. 6 illustrates the two relative positions of the grid 40 at Z1 and Z2. The light beam 48 projected from light source 44 intersects the grid 40 at different positions at grid positions Z1 and Z2, thereby causing the position of the spot 46 imaged on camera 42 to differ in X for the two grid positions.

The camera is used as before to determine the relative displacement in the XY plane. The camera may be provided with auto focussing means to enable the camera to adequately detect the dots at different distances from the grid.

FIG. 9 illustrates an embodiment in which the sensor is able to measure translation in Z even though the sensor is constrained to move only in the XY plane. In this embodiment the sensor 12 is constrained so that it has translational movement in two degrees of freedom in the XY plane and rotational movement about the Z axis. The measurement scale 10 comprises a translucent structure onto which the scale pattern is printed. The sensor 12 is positioned below the measurement scale and is in a fixed relationship via a bracket 70 to a mounting structure 72 onto which a laser 74 is mounted. The laser 74 is directed towards the sensor 12, at an angle. The mounting structure 72 enables the laser 74 to be translated in Z, whilst constraining it in the other five degrees of freedom. As the measurement scale 10 is translucent, the sensor is able to detect the laser dot and as the laser moves in Z, detect its movement. A device such as a camera or probe may be mounted on the mounting structure 72 and its movement may thus be measured in four degrees of freedom, i.e. translationally in X,Y and Z and rotationally about Z.

In an alternative embodiment shown in FIG. 7, the camera may be replaced by two cameras 52,54 angularly offset to one another. Both camera 52,54 are focussed onto the same location on the grid 50. As the relative displacement in Z between the grid 50 and the cameras 52,54 changes, the pattern detected by each of the cameras 52,54 will change. This change can be used to measure the relative displacement in Z.

At a first relative position of the grid Z1, two dots 56,58 are detected by both cameras 52 and 54. At a second relative position of the grid Z2, camera 52 only detects the dot 56 and camera 54 detects no dots. The outputs from camera are sent to a controller. The output of the cameras 52,54 are combined to determine the displacement of the camera relative to the grid in the XY plane. The difference in outputs from the cameras 52,54 are used to determine the Z displacement of the cameras 52,54 relative to the grid 50.

Another method of determining the relative height of the grid and camera is illustrated in FIGS. 10 and 11. FIG. 10 illustrates the view of the grid when the camera is at a first height h1 above the grid and FIG. 11 illustrates the view of the grid when the camera is at a second height h2 above it.

The output of each pixel in the camera is used to best fit the image with the expected image at any particular height and orientation. The relative height of the grid and camera is thus determined from this best fit operation. This method has the advantage that it only uses a single algorithm.

Furthermore, it has the advantage that it can accurately determine the relative height of the grid and camera at both small and large distances. This therefore gives a better result than counting the dots in the field of view for different heights, as this is only accurate for larger distances. It also gives a better result than measuring dot diameter which is only accurate for smaller distances.

This method also has the advantage that as all the camera pixels are used, then if any pixel produces an erroneous signal, the error has little effect on the overall result. This is unlike the method of comparing the diameter of the dots, in which case the error from a single pixel could have a larger effect.

The invention may also be used to measure rotation on a linear scale. FIG. 8 illustrates a linear scale 60 and a readhead 62 movable relative to the scale. The linear scale 60 comprises a linear array of units 64, each having a data dot 66 and a pattern of coloured dots 68. As with the 2D grid, the coloured dots 68 identify the unit and the image of the black dot 66 on the sensor of the readhead enables the exact position of the readhead to be determined.

If a 2D sensor is used, then by determining the XY position of two black dots, their relative orientation and thus the orientation of the scale and readhead can be determined. This enables non-linear movement of the readhead relative to the linear scale to be measured.

A further embodiment of the invention is illustrated in FIG. 12. In this embodiment, two sensors 80,82 (e.g. cameras) are used to detect the pattern of dots on the grid 84. The two sensors 80,82 are spaced a distance d apart, for example 50 mm or 100 mm and are fixed relative to one another by a bar 86. Both sensors are orientated towards the grid, parallel to one another. Rather than detecting two dots in the field of view of a single sensor to determine relative orientation of the grid and sensor, one dot detected by each sensor is used for this calculation. This arrangement has the advantage that the dots used in the calculation are separated by a significant amount and thus it is more accurate than using two adjacent dots in the field of view of a single sensor, which may be spaced apart for example 1.5 mm apart.

It is desirable for the apparatus of the present invention to have good rideheight tolerance. FIG. 13 illustrates an image taken by a sensor of a marker feature (e.g. black dot) 88 on the grid 84. In order to determine the position of the sensor relative to the grid, the position of the image of the marker feature on the sensor must be determined. As the real position of the marker feature on the grid is known (from the colour coded dots, for example), the relative position of the sensor may be determined. To determine the position of the marker feature 88 on the sensor, the number of pixels are counted from the image of the marker feature to a datum position 90 (e.g. the centre of the image) in both X and Y directions. In order to determine the distance of the image of the marker feature from the datum position, the number of pixels is multiplied by a pixel scale factor. However, this method of determining the position of the marker feature has the disadvantage that the pixel scale factor varies with rideheight of the sensor relative to the grid.

The position of the sensor relative to the grid may be determined without requirement of the pixel scale factor, by using two marker features to determine the relative position of the sensor in each direction (X,Y). FIG. 14 illustrates the image produced by the sensor. The image of two marker features 90,92 on the grid are used to determine the position of the sensor relative to the grid in the X direction. The positions of the marker features on the grid in the X direction are known. The distance of the images of these marker features from the datum position (i.e. the centre of the image) can be inferred from the ratio of the distances between the centre pixel and the image of the two marker features as this is the same as the ratio of the actual distance to the camera centre and the distance to the known coordinates of the marker features.

Thus for the example in FIG. 14, the centre of the sensor has a position of X=100+2/3(102−100) and Y=198+1/2(200−198).

The pixel scale factor is not required and thus this embodiment is tolerant to rideheight.

The position data of the dots on the grid is determined by scanning the field of view 94 of the camera. This is typically done as a raster scan, reading information from each pixel in turn along the top row 96 and then repeating this method for each subsequent row, as illustrated by the arrows 98,100 shown in FIG. 15.

FIG. 16 illustrates four dots A, B, C and D in the field of view of the camera. Reading the data from the pixels using the raster scan as described above, the measurement data of dot A will be read first, followed by dot B, dot C and finally dot D. if there is relative movement between the sensor and grid, then the position of dot D may have changed by the time the output from the pixels in its vicinity are read.

The position shift of the two bottom dots C and D from where they are expected to be can be used to determine the relative velocity of the grid and sensor. Where there is slow relative velocity, a good image of dots C and D will result and the positions of dots C and D can be differentiated to give accurate position data. Where there is fast relative velocity, an unclear image of dots C and D will result and the change in position of the dots can be used to measure the relative velocity.

The two dimensional measurement grid and associated sensor have many potential uses. One such use is with an X-Y planar motor, such as those used for testing PCBs (e.g. a flying probe test system). The relative position of parts of an X-Y planar motor can conventionally be determined by computation from the magnetic grid to an accuracy of the order of millimetres. By using the measurement grid and sensor of the present invention, the relative positions of moving parts can be determined to an accuracy of the order of micrometers. Furthermore, the measurement grid of the present invention has the advantage that it can easily be manufactured in large sizes, so it is suitable for use in large machines, for example the above mentioned flying probe test systems may have a size of over 1 m². Machines such as flying probe test systems are typically already provided with cameras which may also be used as the sensor for the measurement grid.

The measurement grid and sensor is also suitable for use in laboratory instruments having two-dimensional stages, for carrying out procedures such as assays. Typically these two-dimensional stages use stepper motors or linear motors to control the relative position of moving parts. A two dimensional measurement grid may be located in a corner of the instrument as a calibration grid. Alternatively, a calibration artefact could be provided with a measurement grid, the calibration having similar dimensions to a well plate. These instruments are typically provided with cameras, e.g. for monitoring reactions in assays, and these cameras can be used as the sensor for the measurement grid.

The measurement grid and sensor are suitable for instruments which are already provided with a camera or other sensor which can also be used as the sensor for the measurement grid. For example, the measurement grid and sensor are suitable for use in a microscope. This has the advantage that microscopes are typically back lit and so do not need an additional light source.

1. A measurement system having a measurement scale pattern and sensor moveable relative to one another, the measurement system comprising:
a measurement scale pattern having a pattern of features arranged into groups, each group having a known absolute position;
at least one sensor, said at least one sensor having a field of view sufficient to detect one or more features simultaneously, wherein relative movement between the said at least one sensor and measurement scale pattern is constrained in two or more degrees of freedom;
a processor to determine the position of the sensor or an object connected to the at least one sensor relative to the measurement scale pattern in at least one linear and one rotational degree of freedom.

2. A measurement system according to claim 1 wherein relative movement between the at least one sensor and the measurement scale pattern is constrained from rotation about axes parallel to the plane of the measurement scale pattern.

3. A measurement system according to claim 1 wherein relative movement between the at least one sensor and the measurement scale pattern is constrained from linear movement in a direction perpendicular from the plane of the measurement scale pattern.

4. A measurement system according to claim 1 wherein the processor uses the detected position of the one or more feature to determine the position of the at least one sensor relative to the measurement scale pattern.

5. A measurement system according to claim 1 wherein the measurement scale pattern comprises a two-dimensional pattern.

6. A measurement scale pattern according to claim 1 wherein the measurement scale pattern comprises a one-dimensional pattern.

7. A measurement system according to claim 1 wherein the at least one sensor comprises a two dimension sensor.

8. A measurement system according to claim 1 wherein the relative position of the measurement scale pattern and the at least one sensor is determined from a single feature.

9. A measurement system according to claim 1 wherein the relative position of the measurement scale pattern and sensor is determined from two or more separate features.

10. A measurement system according to claim 1 wherein each group of features includes a marker feature having a quality which is the same in each group.

11. A measurement system according to claim 10 wherein the marker feature has a quality which is different from all the other features in each group.

12. A measurement system according to claim 11 wherein the marker feature has a different colour from all the other features in each group.

13. A measurement system according to claim 10 wherein two marker features are detected by the at least one sensor and used to determine the relative orientation of the at least one sensor and measurement scale pattern.

14. A measurement system according to claim 1 wherein the position of the features in each group is identical, with only the quality of the features changing between each group.

15. A measurement system according to claim 1 wherein the features have a multilevel coding.

16. A measurement system according to claim 15 wherein the features are chosen from a variety of colours.

17. A measurement system according to claim 1 wherein the group has one or more features which identify the X position and one or more features which identify the Y position.

18. A measurement system according to claim 1 wherein said at least one sensor comprises two sensors in a fixed relationship with one another.

19. A measurement system according to claim 1 wherein the displacement of the image of a feature from its expected position is used to determine the relative velocity between the measurement scale pattern and the at least one sensor.

20. A method of measuring the relative position of a measurement scale pattern and at least one sensor which are moveable relative to one another, the measurement scale pattern being provided with a pattern of features arranged into groups, each group having a known absolute position, and the sensor being constrained in two or more degrees of freedom, the method comprising the steps of:
detecting one or more features of the measurement scale pattern at the at least one sensor;
determining the position of said one or more scale features on the at least one sensor;
and thereby determining the position of the sensor or an object connected to the at least one sensor relative to the measurement scale pattern in at least one linear and one rotational degree of freedom.

21. A method according to claim 20 wherein two or more features are detected by the at least one sensor, and comprising the following steps:
determining the position of the images of the two or more features, whose absolute positions are known;
determining the ratio of the distances between the two or more features and a datum position on the at least one sensor; and
using the ratio of the distances between the two or more features and the datum position to determine the actual distance of the images of the two or more features to the datum position.

22. A measurement scale comprising:
a pattern of features arranged into groups;
wherein each group has a feature, the position of which is known with respect to the group; and
each group has one or more subsidiary feature which defines the position of the group, the subsidiary features being provided with multi-level coding.

23. A measurement scale according to claim 22 wherein each group has a feature, the position of which is known with respect to similar features in other groups.

24. A measurement scale according to claim 23 wherein the feature whose position is known with respect to the group and the feature whose position is known with respect to similar features in other groups are the same feature.

25. A measurement scale according to claim 22 wherein the multi-level coding comprises the use of different colours.

26. A measurement scale comprising:
a pattern of features arranged into groups;
wherein each group has a feature, the position of which is known with respect to similar features in other groups; and
each group has one or more subsidiary feature which defines the position of the group, the subsidiary features being provided with multi-level coding.

27. A measurement system comprising a measurement scale and at least one sensor, the measurement scale and sensor being moveable relative to one another, having the measurement scale according to claim 22.

28. (canceled)

29. (canceled)
